(19) United States
(12) Patent Application Publication
(10) Pub. No.: US 2005/0216828 A1
(43) Pub. Date: Sep. 29, 2005

(54) Patent annotator

(76) Inventor: Thomas J. Brindisi, Venice, CA (US)

Correspondence Address: Thomas J. Brindisi, Esq., Suite B, 20 28th Place, Venice, CA, 90291, US

(21) Appl. No.: 11/092,297

(22) Filed: Mar. 28, 2005

Related U.S. Application Data
(60) Provisional application No. 60/556,930, filed on Mar. 26, 2004.

(51) Int. Cl. G06F 17/24

(52) U.S. Cl. 715/512; 715/531

(57) ABSTRACT

A system and method for processing an existing document (e.g., a patent) to discern useful information (e.g., key text items) and/or relevant locations (e.g., where such information was not originally expressly displayed) in the document, and alter the document by selectively adding discerned useful information to relevant locations. Also, a method and system for preparing a revised drawing from an existing drawing by processing the existing drawing to discern graphically distinct parts of the drawing and selectively insert desired symbolic references to discerned parts, and/or to discern existing text references and selectively replace them with symbolic references; and/or to discern extraneous and/or non-conforming drawing elements and selectively eliminate, modify, or replace them.

### RELATED APPLICATIONS

The present application claims the benefit of Provisional Application Ser. No. 60/556,930 filed on Mar. 26, 2004 and entitled “Patent Annotator,” the disclosure of which is incorporated by reference as if set forth fully herein except to the extent of any inconsistency with the express disclosure hereof.

### FIELD OF THE INVENTION

The present invention generally relates to the field of text and image processing.

### BACKGROUND OF THE INVENTION

Persons such as patent attorneys and paralegals, patent examiners, inventors, and engineers and scientists often have occasion to review and decipher the teachings of patents and patent applications. Because of the rules and conventions of patent drafting, which include the minimization of text references in figures, this process frequently involves a somewhat arduous and menial task (whether it is done at one time or interspersed through the process of reviewing the patent) of reading the text primarily just to identify the names of the various parts corresponding to the reference characters that signify them in the figures. This process is often followed by creation of a list of part names and their corresponding reference characters and/or annotation of the part names directly onto the figures adjacent the parts and/or their references. Similar menial tasks can be encountered in other areas as well such as in the review or processing of instructional illustrations and other types of documents.

Moreover, the preparation of drawings such as patent figures frequently includes drafting tasks that are similarly menial, such as identifying parts and inserting symbolic references and lines to those parts, replacing existing text references with symbolic references (and lines if not already provided), and removing extraneous drawing elements and/or altering drawing elements that do not conform to applicable rules and conventions.

### SUMMARY OF THE INVENTION

In a system and method for processing an existing document in accordance with the present invention, an existing document (e.g., a patent) is processed using a computer programmed and/or configured to discern useful information (e.g., key text items) and/or relevant locations therein, and to permit a user to modify the document by selectively adding discerned useful information to relevant locations in the document (preferably where such information was not expressly displayed in the original document). This system and method may optionally be refined in one or more of the following ways: (a) tuning of optical character recognition (OCR) of images based on characteristics known to be associated with the type of document; (b) tuning OCR based on feedback from results of text processing and/or vice versa; (c) user interaction to permit manipulation of the document processing and modification; (d) incorporation of additional features such as hyper-linking, part coloring, etc.

Alternately, the invention comprises a method and system for preparing a revised drawing (e.g., a patent figure) from an existing drawing (e.g., a sketch or technical drawing) by processing the existing drawing with a computer that is configured and/or programmed to do one or more of the following: (a) discern graphically distinct parts of the drawing and permit a user to selectively insert desired symbolic references to discerned parts; (b) discern existing text references and permit a user to selectively replace them with symbolic references (and lines if not already provided); (c) discern extraneous and/or non-conforming drawing elements and permit a user to selectively eliminate, modify, or replace them.

In both forms of the invention, it may be preferable that the computer retain a record of the modifications made to an original document (such as by saving the modified document in an object-saving format) so that they can be later manipulated, altered, and/or refined, if not indefinitely, at least up until such time as it is determined that no further changes will be desired.

### BRIEF DESCRIPTION OF THE DRAWINGS

FIG. 1 comprises two patent images downloaded from the U.S. Patent Office website in tiff format, the left image being a drawing sheet and the right image being a page containing relevant text;

FIG. 2 is a table displaying text elements recognizable from the left image of FIG. 1, with associated signals conveying information concerning the text elements and cueing the user to interactively modify information displayed in the table;

FIG. 3 is a modified version of the drawing sheet image of FIG. 1, with names of parts annotated thereon;

FIG. 4 is a sequence of images in which the left image is a drawing with no reference characters and the right image is a modified version of that drawing with reference symbols and lines added; and,

FIG. 5 is a sequence of images in which the left image is a drawing with text referencing drawing parts and the right image is a modified version of that drawing with the text replaced by reference symbols.

### DETAILED DESCRIPTION OF PREFERRED EMBODIMENTS

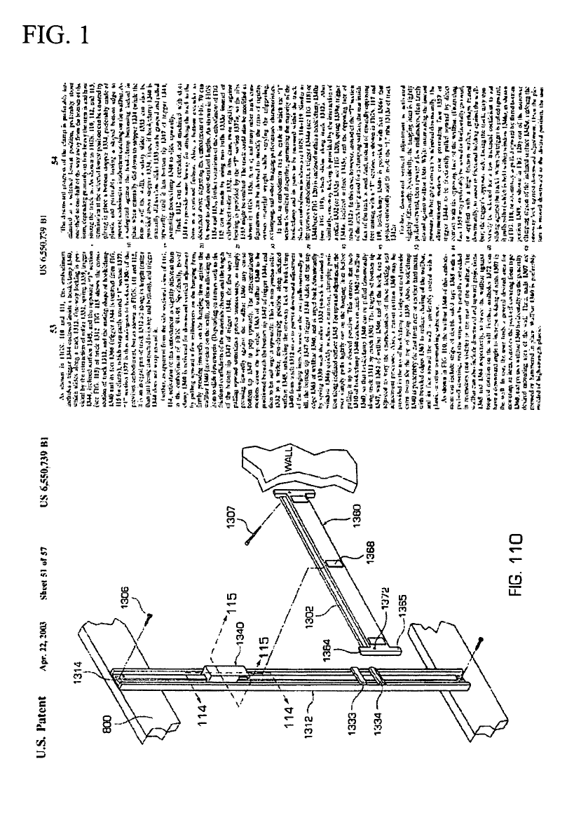

A preferred embodiment of a method and system according to the present invention for processing an existing document to discern useful information and relevant locations therein and to modify the document to add discerned information to relevant locations is now described with reference to FIGS. 1-3. FIG. 1 shows a drawing sheet and a corresponding specification page from a sample patent. In the prior art, a person endeavoring to quickly learn the patent's teachings relating to the figure shown on the drawing sheet would have to flip back and forth to the most relevant section(s) of the specification, and visually scan it to find instances of the many reference numbers included in the drawing. The person may then typically mark up the drawing sheet by hand (not shown) to annotate thereon the names of the referenced parts next to their numbers.

The method and system of the present invention is carried out by a computer configured and/or programmed to perform as described here, such as through a software program loaded on the computer. First, the user determines which patent(s) is of interest and, inputs the number of the patent in response to a first dialog prompt. (Alternately, one or more patent numbers of interest could be obtained through user interaction with a subprogram or linked program designed to perform Boolean searching of patents on a server, or by other suitable means). Preferably the computer is connected to the internet, and the program then causes the computer to download and store a text (e.g., html) copy of the patent from a website such as www.uspto.gov, as is well known. (Alternately, documents could be retrieved from another source such as a compact disc, hard drive, etc.) The program also preferably causes the computer to automatically download the image of the patent, such as by downloading and saving each page of the patent in tiff image format at www.uspto.gov, and preferably then compiling and saving those pages in a multi-page tiff or pdf. In this case, the program also preferably obtains and saves a record of which pages of the image correspond to the various sections of the patent, such as front page, drawing sheets, specification, and claims.

The program then (preferably after cropping off the “U.S. Patent” etc. header by cropping off the top inch) performs optical character recognition (OCR) on the drawing sheet page(s) so as to extract all recognizable text as is well known in the art, preferably looking for text in both landscape and portrait orientations (and optionally also at angles). Next, the program compiles a list of all discrete text items found (in page-by-page lists and/or a cumulative list), and preferably segregates those text items into groups, such as the following: (a) “Fig” “Fig.” “Figure” or the like followed within a specified relative character length (e.g., zero to two spaces) by an e.g., three-or-less-character string; (b) number strings; (c) number strings with an appended letter or symbol (e.g., an apostrophe, prime, quotation mark, etc.); (d) discrete single letters; and (e) everything else. The program then may optionally display a list or table (not shown) displaying the identified figure number(s) preferably correlated to the respective drawing sheet number(s), and if so, preferably provides interactivity permitting the user to review the results and correct any evident errors (such as would occur if, hypothetically, a FIG. 8 includes the text reference “See FIG. 13”, which would cause FIG. 13 to correlate to two drawing sheets unless FIG. 8 and FIG. 13 were on the same drawing sheet), with which corrections the program modifies and resaves the list (preferably with indications of which data are user changes versus automatically obtained).

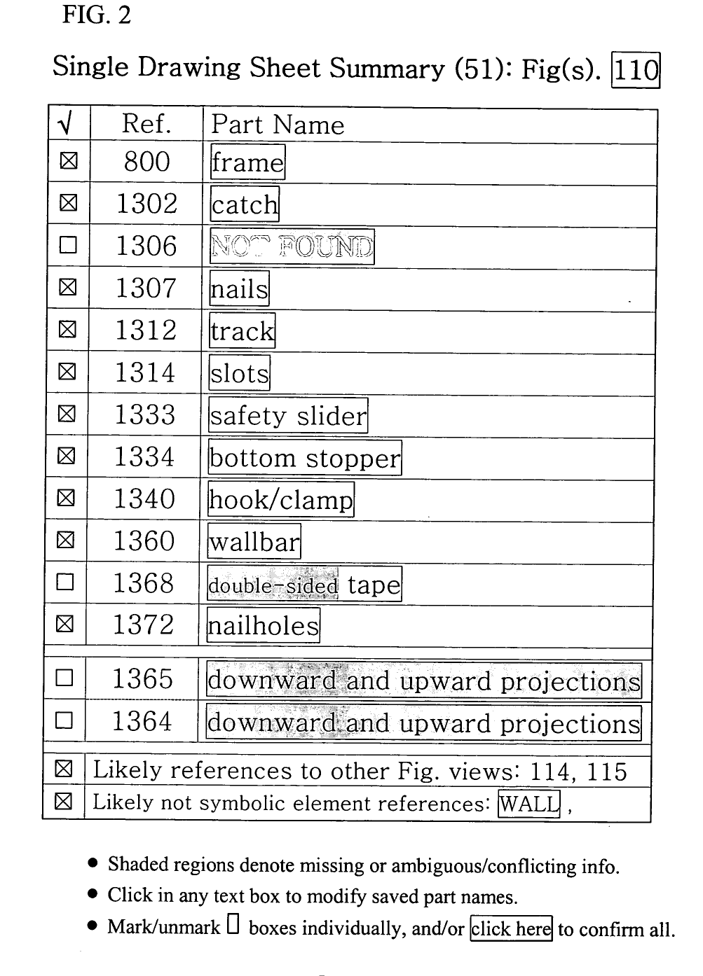

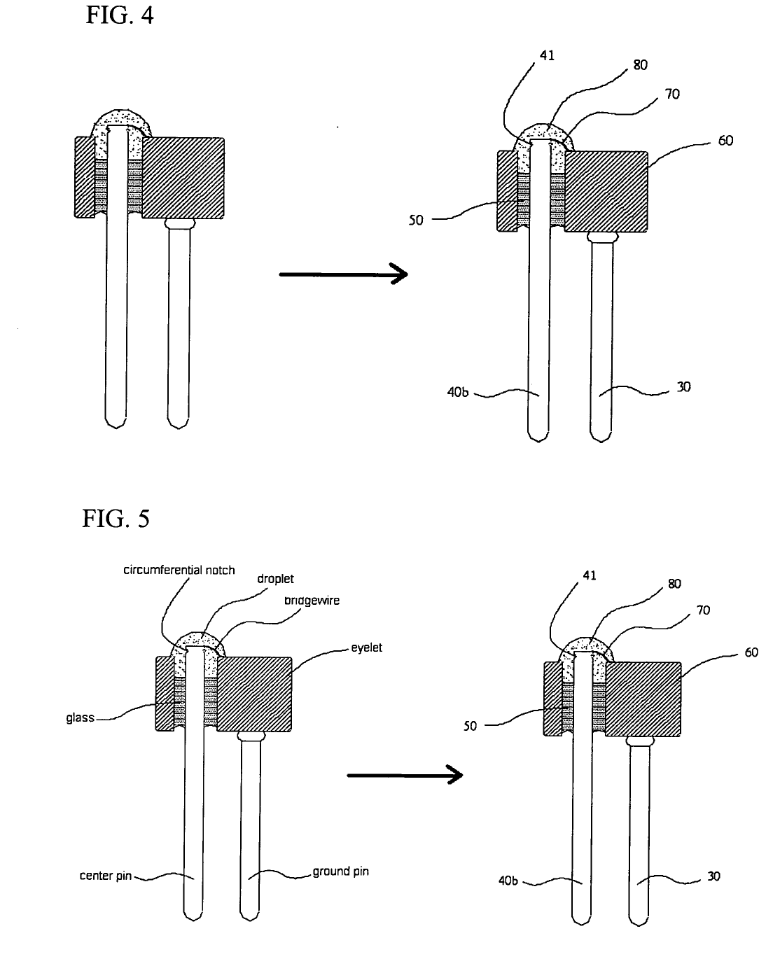

Next, the program searches the text of the corresponding text document for each instance of the reference text items of (b), (c), and (d), to discern the associated part name(s) for such text item, if any. (Optionally, the order of steps could be reversed so that the step described in this paragraph is performed before the step described in the preceding paragraph, with each step suitably modified, including to account for the fact that initial identification of reference text items is obtained from the text first rather than from the images). PCT International Publication Number WO 2003/077154 A3 describes suitable methods for identifying reference text items, particularly at FIGS. 4-8 and the text accompanying them, which disclosure is collectively incorporated hereby by reference as if set forth in full. U.S. Pat. No. 5,774,833 to Newman (particularly at col. 9, lines 1-45) also describes a method for identifying numbered figure elements in the detailed description of a text document version of a patent, the teachings of which are also incorporated herein by reference as if set forth in full. The text searching may be limited to only the Detailed Description of the patent text as described in the Newman patent (which is incorporated herein by reference), or if that is not desired, additional measures may be implemented to disregard numbers used in claims as will be readily recognized (e.g., disregarding any instance of a number that is followed by a period and “A” or “An” and/or is followed within a predetermined number of characters by “claim”). Alternate and/or additional measures may be taken to further hone and/or render more concise matching to the text of the reference text items identified from the drawings and identification of part names for them. For example, a predetermined number of words, e.g., five, preceding each instance of a reference text item may be compared to the same number of preceding words for all other instances, and truncation then effected back to where the words are common among each instance. Further truncation may preferably be effected back to any “the” “a” “an” or similar article, and the resulting term saved and associated with the corresponding reference text item. (Definite Clause Grammars and Prolog programming language can also be used in identifying part names; see generally Ivan Bratko, “Prolog programming for Artificial Intelligence” (Addison Wesley 2^{nd} Ed., 1990), ISBN 0-201-41606-9). The computer may also preferably cause other terms to be saved as secondary information associated with the reference character, such as additional words in cases where more than one, but not every, instance includes a longer common term, and/or such as alternate words in cases of ambiguous references. If an identified reference text item of group (b)-(d) is not found whatsoever in the patent text (e.g., reference 1308 in FIG. 1), and such item is not a Figure number used in the text, a “missing” code is preferably associated with that reference character (and preferably communicated to the user such as the “not found” in FIG. 2). If such item is a Figure number used in the text (e.g., 114 and 115 in FIG. 1), a “probable other Figure view reference” code is preferably associated with that reference character (and preferably communicated to the user such as in FIG. 2).

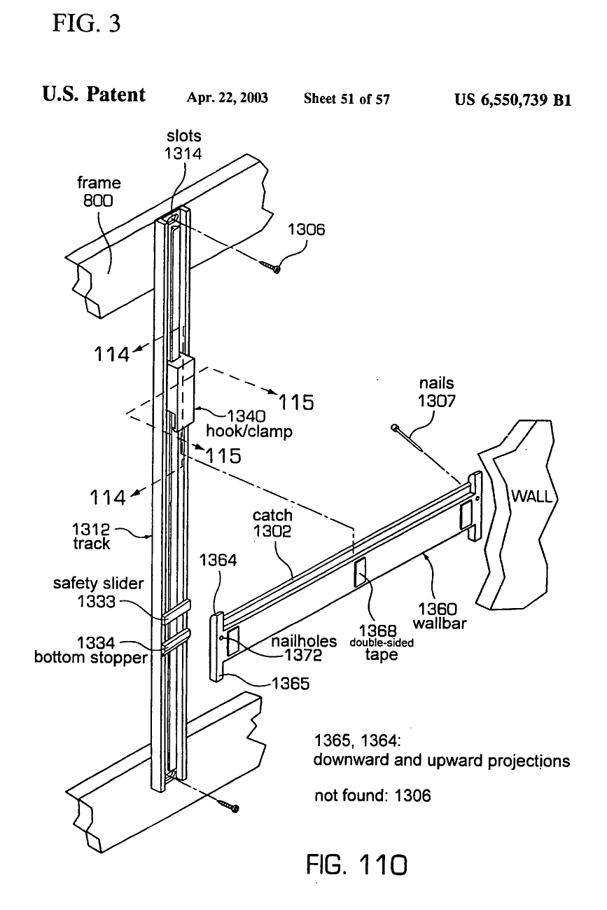

As shown in FIG. 2, the program then preferably displays a list or table containing (preferably at least the above-noted groups (b)-(d) of) the reference text elements identified from the drawings, correlated to their tentatively or default identified names, and preferably visually grouped in a logical order as shown in FIG. 2 (other visually articulated categories not shown in FIG. 2 may also preferably be displayed depending on the results of analyzing the particular document), again with user-interactivity permitting corrections and modifications as desired. Secondary information such as noted above (e.g., additional/conflicting words) are also preferably displayed (such as the additional term, “double-sided” shown in FIG. 2 in connection with reference number 1368), preferably with suitable signals to the user permitting convenient reinstatement/deletion of the additional secondary words or selection between conflicting or alternate words, resulting in a final “name” for each item and thus for each corresponding part of the drawing. The program may also preferably signal the user to consider manually further truncating names in the list that exceed, e.g., three words or a predetermined number of characters. If the only instance(s) of two or more reference characters in the specification text is immediately separated from one or more other reference characters by an “and” or a comma, such groups are preferably treated as conglomerates (and they are preferably displayed as such in a separate list on the modified figure, as shown toward the bottom right of FIG. 3), and should be displayed so as to invite the user to revise the names for them (as with 1364 and 1365 in FIG. 2), in which case the table would be regenerated (not shown) with the newly-confirmed part names integrated in the main listing. (Also not shown in FIG. 3 is labeling of 1364 and 1365 that would occur upon such correction). The program may also record information concerning the location in the text of each instance of a reference text item, and/or may create hyperlinks between the relevant locations in the drawings and text. Hyperlinking to instances of matching references in the text version of the patent (preferably with a “next” and “back” feature to permit jumping forward among multiple linked instances of the same reference) may be utilized by the user to facilitate more rapid review and if necessary correction of possible errors or other issues, and elimination of erroneous or undesired candidates.

The program is preferably configured to permit the procedures outlined above to be performed by the user page-by-page or all at once on all drawing sheet pages. After the user is satisfied and accepts and/or modifies and confirms all tentative or default information (see FIG. 2, bottom user instruction), the program causes a modified version of the relevant drawing sheet page(s) to be produced with the part names annotated thereon. Alternately, a user preference may be set to automatically accept all tentative and default values identified by the program and automatically proceed immediately to creating, saving, and printing the modified document.

The program preferably selects the positioning and orientation for annotation of the part names with reference to the location, estimated font size, and orientation of the reference text items (each of which were preferably discerned and stored during the initial OCR step). This works as follows. First, at the location in the drawing image of the particular reference text item (which is, e.g., a rectangle), a predetermined zone (e.g., a rectangle centered around, but three times the height and width of, the rectangle defined by the reference text item itself) is analyzed for a suitable maximal “whitespace” region preferably aligned in the same orientation as the reference text item itself. The maximal whitespace rectangle in the selected zone may be identified per the teachings of Thomas M. Breuel, “An Algorithm for Finding Maximal Whitespace Rectangles at Arbitrary Orientations for Document Layout Analysis,” in the Proceedings of the Seventh International Conference on Document Analysis and Recognition (IEEE Computer Society 2003, ISBN 0-7695-1960-1), a copy of which is included with this specification and incorporated herein as if set forth in full, with suitable modifications for the present context as will be readily evident to one of ordinary skill. It is also noted that the program may perform a conventional “despeckle” image processing step if a suitably large whitespace is not identified. Also, the font size of the text to be annotated, which may by default preferably be the same as that of the reference numbers in the drawing sheet, may be globally (for the sheet) reduced in order to reduce the size of the required whitespaces until no more, or a predetermined number of, non-fitting cases exist. Such global reduction should also correspondingly further reduce the font of any particular parts chosen for de-emphasis (e.g., additional words of a part name used in some but not all instances in the text). The whitespace analysis may also preferably be tuned to search preferentially nearest to the rectangle defined by the reference text item itself, and also preferentially among quadrants of the zone (preferences being, e.g., in the order of centered-below, centered-above, to the sides, off-center below or above, and at an angle and below, above, or to the side), and stop searching when the first suitable whitespace is found. It may also be dynamically tuned to optimize the overall placement of part names when there are multiple reference text items in close proximity. In cases where no suitably large whitespaces are found for less than a predetermined number of reference text items on a page—or as an alternative to locating any whitespaces in the first place—the user may be provided with the option (or a changeable default implemented in the user preferences) of having the part name displayed in a white rectangle (preferably just larger than the rectangle defined by the part name) laid opaquely (or partially opaquely) on the drawing image, rather than decreasing the font to a potentially unsuitably small size to accommodate the annotation. Also, the program may preferably break multiple-word names into multiple lines, especially if it assists in fitting the part name to the shape of an identified whitespace.

As shown in FIG. 3, once suitable locations have been found in the foregoing fashion, the part names are annotated in the whitespaces (or opaque layover) in a font preferably similar to the native font of the reference text items of the drawing sheet as best identified by OCR. As shown toward the bottom right of FIG. 3, items that have not modified by the user into ordinary part names may preferably be listed appropriately in a suitable large whitespace in the drawing. After annotation, the resulting drawing sheet page(s) can then be saved (preferably in an object-saving format) in a multi-page document preferably comprising the entire patent (with modified drawings) and printed by the user for review.

Alternately, an intervening user interactive step can be permitted before the final annotation. In that case, the program preferably displays the modified drawing sheet page(s) on the screen (not shown) and preferably permits the user to interact with them, such as by “clicking” on annotated part names to directly edit them, move them, or otherwise alter the annotated drawing. Optionally, hyperlinks to the corresponding text may be utilized to aid in this process. (Hyperlinks may also preferably be retained even after final creation of the modified document, for later utilization). In this step and prior ones, whenever the user modifies a part name, the part of the name derived from the user may preferably by default be visually distinguished (such as by italic typeface) and parts of the name omitted visually signaled (such as by a small dot or dash).

It is noted that an OCR subprogram for use in the present embodiment may optionally be pre-tuned to enhance recognition of commonly used patent drafting fonts. The OCR step may also be repeated after the first step (or more steps) of text processing to optimize recognition of reference characters appearing frequently in the text and facilitate better automatic matching between the two. Likewise, feedback from OCR results may be used (once or iteratively) to heuristically tune the text processing toward the goal of maximizing correct and complete identification and/or recognition of reference characters. Also, the user interfaces of the present embodiment may include an ability to manipulate which and/or how discerned information is to be displayed, such as by selective deletion, correction, emphasis (e.g., bold, italics, colors, font sizes, etc.), or other display alteration (e.g., transparent versus opaque box, horizontal versus vertical versus best available angle text orientation, etc.). Also, a feature may be provided to permit a simplified (be it partial or global) list of part references and corresponding names to be created and printed out.

As an alternative or addition to part(s) of the embodiment as described above, images of the detailed description portion of the patent may be processed with OCR to identify the relevant part names. Although OCR of a large expanse of text may incur errors, an advantage is that reference characters are bolded in the image version, which may allow them to be more readily identified therefrom than from the text version.

As another alternative or addition to part(s) of the embodiment as described above, the program may also or alternately permit the user to have identified reference text items whited-out from the drawings and the part name annotations put in their place (not shown).

As another alternative or addition to part(s) of the embodiment as described above, a feature can be provided to permit the user to specify a Figure or reference character of interest, in response to which the program locates and cuts out a relevant text section from the image version of the specification text, which it can then print, e.g., side-by-side with a figure. Location of the relevant span(s) of text could proceed upon identification of a predetermined number of lines before and after each instance of the Figure number or reference, or all paragraphs including it, or in the case of a Figure, starting with the first instance of that Figure up to the end of the paragraph containing the first instance of another Figure. (Searching within html for matching reference text figures as described earlier may also be optionally focus preferentially on such corresponding sections of text).

A preferred embodiment of a method and system according to the present invention for preparing a revised drawing from an existing drawing is now described with reference to FIGS. 4 and 5. As shown in the left side of FIG. 4, an existing sketch or technical drawing may lack part references but may be suitable for convenient image processing to identify contiguous like-filled sections, as is well known in the art. A computer program may preferably provide an interactive display identifying (e.g., with different colors) candidate contiguous elements of a drawing on the computer screen, and permitting the user to remove superfluous candidates and/or add new ones by pointing out relevant locations. Once the user has selected which parts are desired to be identified in the revised drawing, a next interactive display invites the user to enter the names for each part. With that information entered, a next interactive display appends proposed two-point curved lines to each part, with the name of each part at the remote end of each line. The user is then invited to confirm them one-by-one or all at once, or to modify any by moving the endpoints and/or curve points of the lines. The program preferably includes a feature permitting the user to “toggle” between views with and without the annotated references and lead lines. A feature permitting automatic optimization of overall reference number arrangement may also be provided.

Alternately or additionally, as shown in the left side of FIG. 5, an existing sketch or technical drawing may include part references in the form of names rather than symbolic references. As noted earlier, such text references may be identified by OCR per well-known techniques. Each text item may then be automatically whited-out and, in an interactive display, replaced with an editable text box containing the same text, inviting the user to replace the existing text with a symbolic reference as shown on the right side of FIG. 5. A further feature may be provided permitting identification of reference lines (if pre-existing) so that they can be replaced with dynamic lines that can be moved; if reference lines were not pre-existing, then the program should of course permit the placement of such as described with reference to FIG. 4. Preferably, the program retains a record of the original part names so that the user can toggle between the three modes of: (a) text name only, (b) symbolic reference only, or (c) text and symbolic reference (in which case the combined reference may optionally be positioned by maximal whitespace identification). A feature permitting toggling on and off of the lead lines may also be provided.

Preferably in one or both embodiments of FIGS. 4 and 5, a “fill” feature may be provided to automatically fill parts with like hatching among figures once the user has identified them with reference (or vice versa).

Also, a program may be provided to discern predetermined extraneous and/or undesired drawing elements such as dashed centerlines and permit a user to selectively eliminate, modify, or replace them.

Preferably, an integrated software program may incorporate features of more than one, if not all, of the embodiments of FIGS. 1-3, 4 and 5, such that revised drawings can be created and existing drawings more easily reviewed with the same program. In any case, it will be readily apparent to one of ordinary skill that various features of each may be applied to the other, for example, the toggling feature described with reference to the embodiment of FIGS. 4 and 5 may likewise be applied to the embodiment described with reference to FIGS. 1-3.

Preferred embodiments of a method and system for discerning useful information and/or relevant locations in a document, and modifying the document by selectively adding discerned useful information to such relevant locations, and of a method and system for preparing a revised drawing from an existing drawing have thus been disclosed. It will be apparent, however, that various changes may be made in the form, construction, and arrangement of the method and system without departing from the spirit and scope of the invention, the form hereinbefore described being merely a preferred or exemplary embodiment thereof. Therefore, the invention is not to be restricted or limited except in accordance with the following claims.

1. A method for processing a selected existing document containing text and graphics, wherein the method includes the following steps carried out by a computer:
a) discerning useful text in the selected existing document; and,
b) correlating useful text in the selected existing document to logically corresponding locations in the graphics in the selected existing document.

2. The method of claim 1, further comprising the step of the computer annotating useful text on and/or adjacent to graphics at and/or near logically corresponding locations in the selected existing document.

3. The method of claim 1, wherein said method includes the following steps carried out by a computer:
i) performing OCR on graphics in the selected existing document; and,
ii) performing analysis of text in the selected existing document to identify selected classes of possible reference text items.

4. The method of claim 3, wherein one or more of steps i) and ii) are repeated at least once, and at least one of the repeated steps incorporates results from a prior iteration of one or both of steps i) and ii).

5. The method of claim 3, further including the step of soliciting user input.

6. The method of claim 3, wherein step i) is first performed before step ii) is ever performed.

7. The method of claim 3, wherein the existing selected document is a patent.

8. The method of claim 3, further comprising the step of the computer annotating useful text on and/or adjacent to graphics at and/or near logically corresponding locations in the selected existing document.

9. The method of claim 8, wherein step i) is first performed before step ii) is ever performed.

10. The method of claim 9, wherein one or more of steps i) and ii) are repeated at least once, and at least one of the repeated steps incorporates results from a prior iteration of one or both of steps i) and ii).

11. The method of claim 11, wherein the existing selected document is a patent, and wherein the method includes the step of obtaining both a text version of the patent and an image version of the patent.

12. A software program configured to perform the steps of the method of claim 11.

13. A method for preparing a revised drawing from an existing drawing, comprising the following steps carried out in a computer:
a) processing the existing drawing to discern graphically distinct parts of the drawing; and,
b) selectively inserting in the drawing symbolic references to discerned parts.

14. The method of claim 13, further comprising the step of discerning extraneous and/or technically non-conforming drawing elements and selecting and eliminating, modifying, and/or replacing them.

15. The method of claim 13, wherein the symbolic references are at least in part predetermined.

16. The method of claim 13, wherein the symbolic references are at least in part selected by interaction with a user.

17. A method for preparing a revised drawing from an existing drawing, comprising the following steps carried out in a computer:
a) processing the existing drawing to discern existing text references; and,
b) selectively replacing in the drawing discerned text references with symbolic references.

18. The method of claim 17, further comprising the step of discerning extraneous and/or technically non-conforming drawing elements and selecting and eliminating, modifying, and/or replacing them.

19. The method of claim 17, wherein the symbolic references are at least in part predetermined.

20. The method of claim 17, wherein the symbolic references are at least in part selected by interaction with a user.
